(19) United States
(12) Patent Application Publication
(10) Pub. No.: US 2015/0212250 A1
(43) Pub. Date: Jul. 30, 2015

(54) LIGHT GUIDE MODULE AND BI-STABLE DISPLAY DEVICE HAVING THE SAME

(71) Applicant: E Ink Holdings Inc., Hsinchu (TW)

(72) Inventors: Sheng-Chieh TAI, Hsinchu (TW); Chia-Chuang HU, Hsinchu (TW); Shu-Li HSIAO, Hsinchu (TW)

(21) Appl. No.: 14/501,062

(22) Filed: Sep. 30, 2014

(30) Foreign Application Priority Data
Jan. 24, 2014 (TW) 103102720

(51) Int. Cl. F21V 8/00; G02F 1/167

(52) U.S. Cl. CPC G02B 6/0031; G02B 6/0073; G02F 1/167

(57) ABSTRACT

A light guide module includes a light guide plate, a light source, and a reflector. The light guide plate has a light mixed region and a visible region. The light-mixed region is at the edge of the light guide plate, and the light mixed region has a first surface and a second surface at an opposite side to the first surface. The first surface has a plurality of first concave convex structures. The light source faces the second surface of the light-mixed region. When the light source emits a light, the light enters the light mixed region from the second surface, and the light is reflected to the visible region by the first concave convex structures. The reflector covers the first concave convex structures, and plural gaps are formed between the reflector and the bottom portions of the first concave convex structures.

### RELATED APPLICATIONS

This application claims priority to Taiwanese Application Serial Number 103102720, filed Jan. 24, 2014, which is herein incorporated by reference.

### BACKGROUND

1. Field of Invention

The present invention relates to a light guide module and a bi-stable display device.

2. Description of Related Art

In the current consumer electronic product markets, electrophoresis display devices are extensively used in portable electronic devices like electronic books as display screens. An electrophoresis display device comprises a display medium layer (or referred to as electronic ink) which is mainly formed by a clear fluid, and white and black charged particles doped in the clear fluid. The white and black charged particles may be driven to move under the application of a voltage to the display medium layer, so as to make each of pixels present a color of black, white or gray level.

In the conventional art, the electrophoresis display device utilizes an external or ambient light irradiating the display medium layer for displaying, so that the electrophoresis display device needs no backlight and saves the electrical consumption. In order to expand the applications of the electrophoresis display device, a front light module may be arranged above the front panel laminate of the electrophoresis display device. If the electrophoresis display device is used in a condition of insufficient ambient light, the front light module can emit an incident light to the display medium layer to facilitate users watching images through the electrophoresis display device.

A light emitting diode (LED) has been used to emit light to the side surface of a light guide plate, and the light through the light guide plate irradiates the electrophoresis display device. Miniaturization is a trend in the development of the display devices. However, light leakage may occur when the thickness of the light guide plate is reduced to 0.25 millimeter (mm) or less and the LED with the thickness of 0.3 mm or more is used. Since the LED is located at the side surface of the light guide plate, the direction of the leaked light and the light guide direction within the light guide plate are the same, so as to affect the optical quality of the visible region of the light guide plate. As a result, the thickness of the LED light source is limited by the thickness of the light guide plate, which is an inconvenient factor for designers.

### SUMMARY

An aspect of the present invention is to provide a light guide module.

According to an embodiment of the present invention, a light guide module includes a light guide plate, a light source, and a reflector. The light guide plate has a light mixed region and a visible region. The light mixed region is at an edge of the light guide plate. The light mixed region has a first surface and a second surface at an opposite side to the first surface. The first surface has a plurality of first concave convex structures. The light source faces the second surface of the light mixed region. When the light source emits a light, the light enters the light mixed region from the second surface, and the light is reflected to the visible region by the first concave convex structures. The reflector covers the first concave convex structures. A plurality of gaps are formed between the reflector and a plurality of bottom portions of the first concave convex structures.

In one embodiment of the present invention, the reflector is made of a material including silver, aluminum amalgam, silver paint, or white paint.

In one embodiment of the present invention, the light source is aligned within the first concave convex structures.

In one embodiment of the present invention, the thickness of the light guide plate is h, and the thickness of each of the first concave convex structures is in a range from 1 micrometer to 0.9 h.

In one embodiment of the present invention, the second surface has a plurality of second concave convex structures, and the second concave convex structures face the light source.

In one embodiment of the present invention, the first concave convex structures are continuous concave convex surfaces.

In one embodiment of the present invention, the cross-sectional shape of each of the first concave convex structures is triangle.

In one embodiment of the present invention, each of the first concave convex structures includes two walls connected with each other, and the two walls are flat surfaces.

In one embodiment of the present invention, the included angle of the two walls is in a range from 20 to 80 degrees.

In one embodiment of the present invention, each of the first concave convex structures includes two walls connected with each other, and the two walls are respectively a flat surface and a curved surface.

In one embodiment of the present invention, each of the first concave convex structures includes two walls connected with each other, and the two walls are curved surfaces.

In one embodiment of the present invention, the top view shape of the first concave convex structures is a straight line, a polyline, or a curve.

In one embodiment of the present invention, an acute angle is between a connection line of a plurality of top portions of the first concave convex structures and a horizontal line.

In one embodiment of the present invention, the light guide module is a front light module of a bi-stable display device.

In one embodiment of the present invention, the light source is a light emitting diode.

Another aspect of the present invention is to provide a bi-stable display device.

According to an embodiment of the present invention, a bi-stable display device includes a display back plate, a light guide module, and a housing. The display back plate includes an array substrate and a front panel laminate. The front panel laminate is located on the array substrate and includes a transparent substrate and a display medium layer. The display medium layer is between the array substrate and the transparent substrate. The light guide module is located on the display back plate for providing a light for the display back plate. The light guide module includes a light guide plate, a light source, and a reflector. The light guide plate has a light mixed region and a visible region. The light mixed region is at an edge of the light guide plate. The light mixed region has a first surface and a second surface at an opposite side to the first surface. The first surface has a plurality of first concave convex structures. The light source faces the second surface of the light mixed region. When the light source emits a light, the light enters the light mixed region from the second surface, and the light is reflected to the visible region by the first concave convex structures. The reflector covers the first concave convex structures. A plurality of gaps are formed between the reflector and a plurality of bottom portions of the first concave convex structures. Moreover, the housing surrounds the display back plate and the light guide module and covers the light mixed region.

In the aforementioned embodiments of the present invention, the first surface of the light mixed region has the first concave convex structures, and the first concave convex structures may reflect and refract a light. Therefore, when the light of the light source enters the light guide plate from the second surface of the light mixed region, the first concave convex structures can transfer the light to the visible region. The reflector may reflect the light leaked from the first concave convex structures, and may reflect the light into the visible region to improve the light emitting efficiency of the visible region of the light guide plate. Moreover, the light mixed region is at the edge of the light guide plate, and the light source is located at the second surface of the light mixed region. Therefore, the thickness of the light source is not limited by the thickness of the light guide plate, and the light of the light source is only leaked from the first surface and the first concave convex structures of the light mixed region. Practically, the light mixed region is covered by the housing, so that the light guide module can improve the optical aesthetics of the visible region.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a top view of a light guide module according to an embodiment of the present invention;

FIG. 2 is a cross-sectional view of the light guide module taken along line 2-2 shown in FIG. 1;

FIG. 3 is a cross-sectional view of a light guide module according to an embodiment of the present invention, and the cross-sectional position is the same as FIG. 2;

FIG. 4A is a cross-sectional view of a light guide module according to an embodiment of the present invention, and the cross-sectional position is the same as FIG. 2;

FIG. 4B is another embodiment different from the embodiment shown in FIG. 4A;

FIG. 5 is a cross-sectional view of a light guide module according to an embodiment of the present invention, and the cross-sectional position is the same as FIG. 2;

FIG. 6 is a cross-sectional view of a light guide module according to an embodiment of the present invention, and the cross-sectional position is the same as FIG. 2;

FIG. 7 is a cross-sectional view of a light guide module according to an embodiment of the present invention, and the cross-sectional position is the same as FIG. 2;

FIG. 8 is a cross-sectional view of a light guide module according to an embodiment of the present invention, and the cross-sectional position is the same as FIG. 2;

FIG. 9 is a cross-sectional view of a light guide module according to an embodiment of the present invention, and the cross-sectional position is the same as FIG. 2;

FIG. 10 is a top view of a light guide module according to an embodiment of the present invention;

FIG. 11 is a top view of a light guide module according to an embodiment of the present invention;

FIG. 12 is a top view of a bi-stable display device according to an embodiment of the present invention; and

FIG. 13 is a cross-sectional view of the bi-stable display device taken along line 13-13 shown in FIG. 12.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

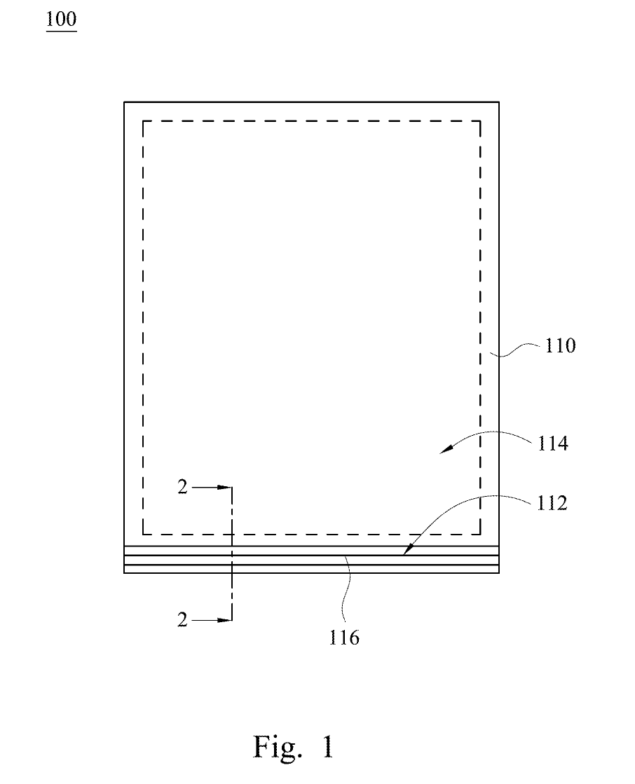

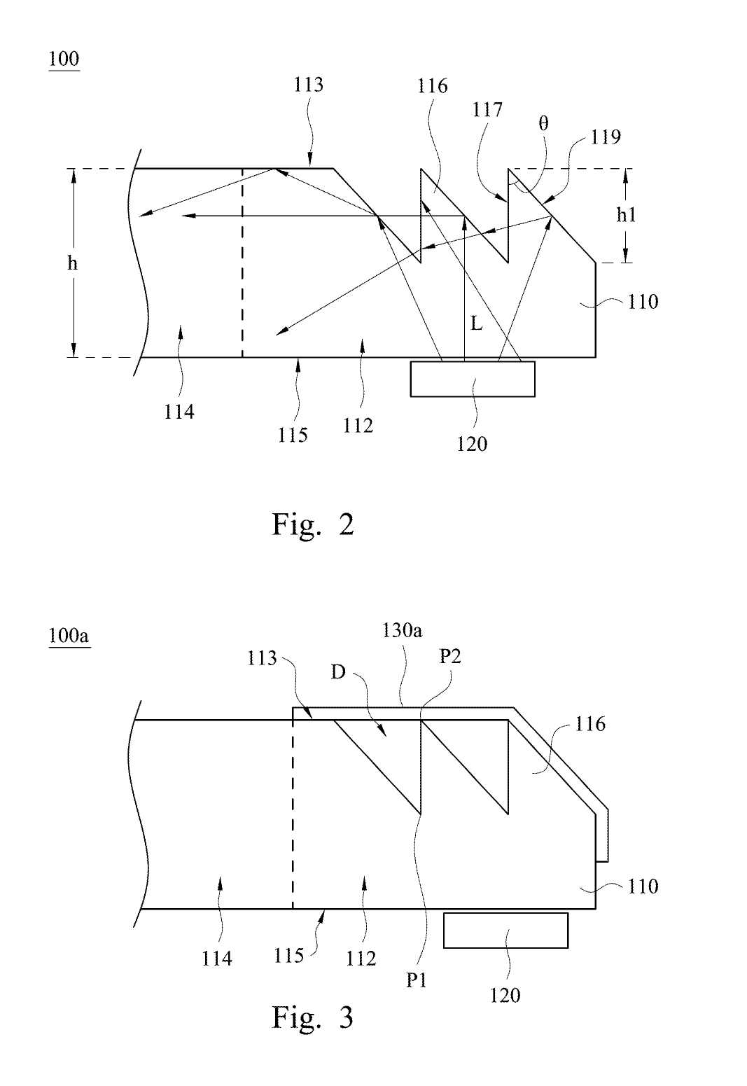

FIG. 1 is a top view of a light guide module 100 according to an embodiment of the present invention. FIG. 2 is a cross-sectional view of the light guide module 100 taken along line 2-2 shown in FIG. 1. As shown in FIG. 1 and FIG. 2, the light guide module 100 includes a light guide plate 110 and a light source 120. The light guide plate 110 has a light mixed region 112 and a visible region 114. The light mixed region 112 is at an edge of the light guide plate 110. The visible region 114 is a range within dotted lines shown in FIG. 1. When the light guide module 100 is used in a display device, the visible region 114 may be referred to as a range displaying images. The light mixed region 112 has a first surface 113 and a second surface 115 at an opposite side to the first surface 113. The first surface 113 of the light mixed region 112 has a plurality of first concave convex structures 116. The light source 120 faces the second surface 115 of the light mixed region 112. The light source 120 may contact the light guide plate 110 or a gap is formed between the light source 120 and the light guide plate 110, and the present invention is not limited in this regard. When the light source 120 emits a light L, the light L enters the light mixed region 112 from the second surface 115, and the light L is reflected to the visible region 114 of the light guide plate 110 by the first concave convex structures 116.

In this embodiment, the light source 120 may be a light emitting diode (LED), but the present invention is not limited in this regard. The light source 120 may be aligned within the first concave convex structures 116, e.g., be aligned with the center position of the first concave convex structures 116, such that the light L is assuredly reflected to the visible region 114 by the first concave convex structures 116. Moreover, when the thickness of the light guide plate is h, e.g., 0.25 mm, the thickness h1 of the first concave convex structure 116 is in a range from 1 micrometer (μm) to 0.9 h as deemed necessary by designers.

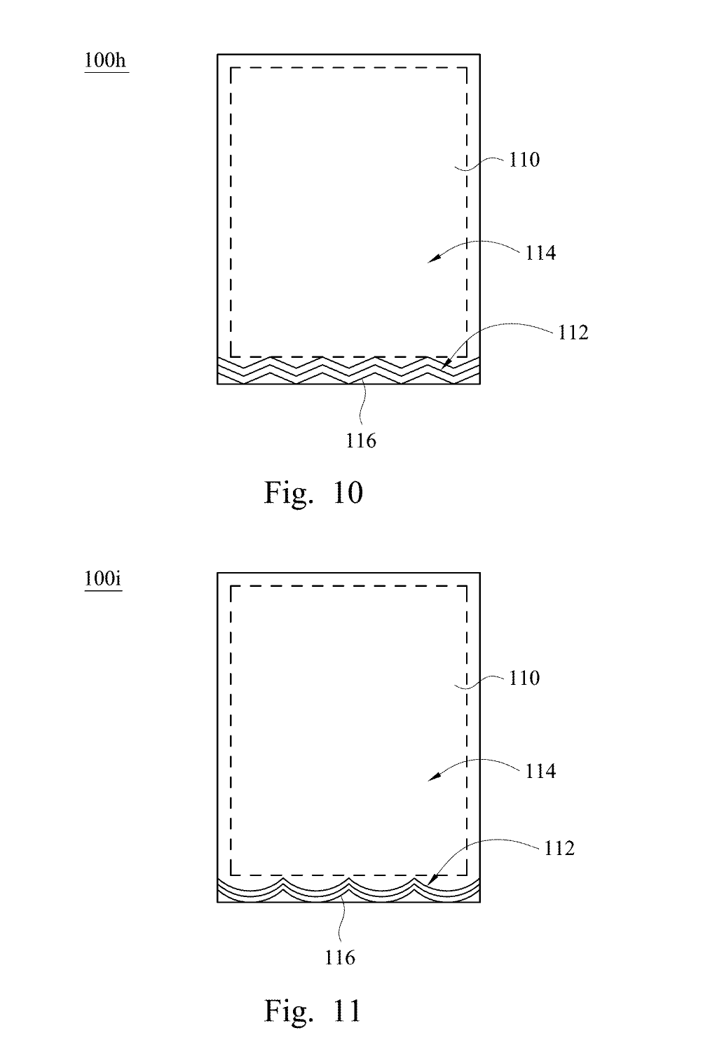

The first concave convex structures 116 may be continuous concave convex surfaces, such that the light guide ability may be improved. In this embodiment, the cross-sectional shape of each of the first concave convex structures 116 is triangle. For example, the first concave convex structure 116 includes two walls 117, 119 connected with each other, and the two walls 117, 119 are flat surfaces. The included angle θ of the two walls 117, 119 may be in a range from 20 to 80 degrees to improve the light guide ability. In addition, the top view shape of the first concave convex structures 116 may be a straight line (shown in FIG. 1), but the present invention is not limited in this regard. The top view shape of the first concave convex structures 116 may be a polyline (shown in FIG. 10) or a curve (shown in FIG. 11).

When the light guide module 100 is in use, the first surface 113 of the light mixed region 112 has the first concave convex structures 116, and the first concave convex structures 116 may be used to reflect and refract the light L. Therefore, when the light L of the light source 120 enters the light guide plate 110 from the second surface 115 of the light mixed region 112, the first concave convex structures 116 can reflect the light L to transfer to the visible region 114, such that the light guide effect may be achieved. Furthermore, the light mixed region 112 is at the edge of the light guide plate 110, and the light source 120 is located at the second surface 115 of the light mixed region 112. Therefore, the thickness of the light source 120 is not limited by the thickness of the light guide plate 110, and the light of the light source 120 is only leaked from the first surface 113 and the first concave convex structures 116 of the light mixed region 112. That is to say, the leakage light direction is substantially perpendicular to the light guide direction.

Practically, however, the light mixed region 112 of the light guide plate 110 is covered by the housing of a display device, users can only see the visible region 114 of the light guide plate 110 above the light guide module 100 shown in FIG. 2. Therefore, the light leaked from the first surface 113 and the first concave convex structures 116 is shielded by the housing, and does not affect the light within the visible region 114. That is to say, the light guide module 100 can improve the optical aesthetics of the visible region 114.

It is to be noted that the connection relationships of the elements described above will not be repeated in the following description. In the following description, other types of the light guide module will be described.

FIG. 3 is a cross-sectional view of a light guide module 100a according to an embodiment of the present invention, and the cross-sectional position is the same as FIG. 2. The light guide module 100a includes the light guide plate 110 and the light source 120. The difference between this embodiment and the embodiment shown in FIG. 2 is that the light guide module 100a further includes a reflector 130a. The reflector 130a covers the first concave convex structures 116. A plurality of gaps D are formed between the reflector 130a and a plurality of bottom portions P1 of the first concave convex structures 116, and the reflector 130a may be supported by the top portions P2 of the first concave convex structures 116. The reflector 130a may reflect the light leaked from the first concave convex structures 116, and may reflect the light into the visible region 114, so as to improve the light emitting efficiency of the visible region 114 of the light guide plate 110 and the optical aesthetics of the visible region 114. In this embodiment, the reflector 130a may be fixed to cover the first concave convex structures 116 by assembling or adhering. The reflector 130a may be made of metal material, or a material that includes silver, aluminum, amalgam, silver paint, or white paint coating on a surface, but the present invention is not limited in this regard.

In the following description, the reflector 130a may be selectively used in each type of the light guide modules to cover the first concave convex structures 116 as deemed necessary by designers.

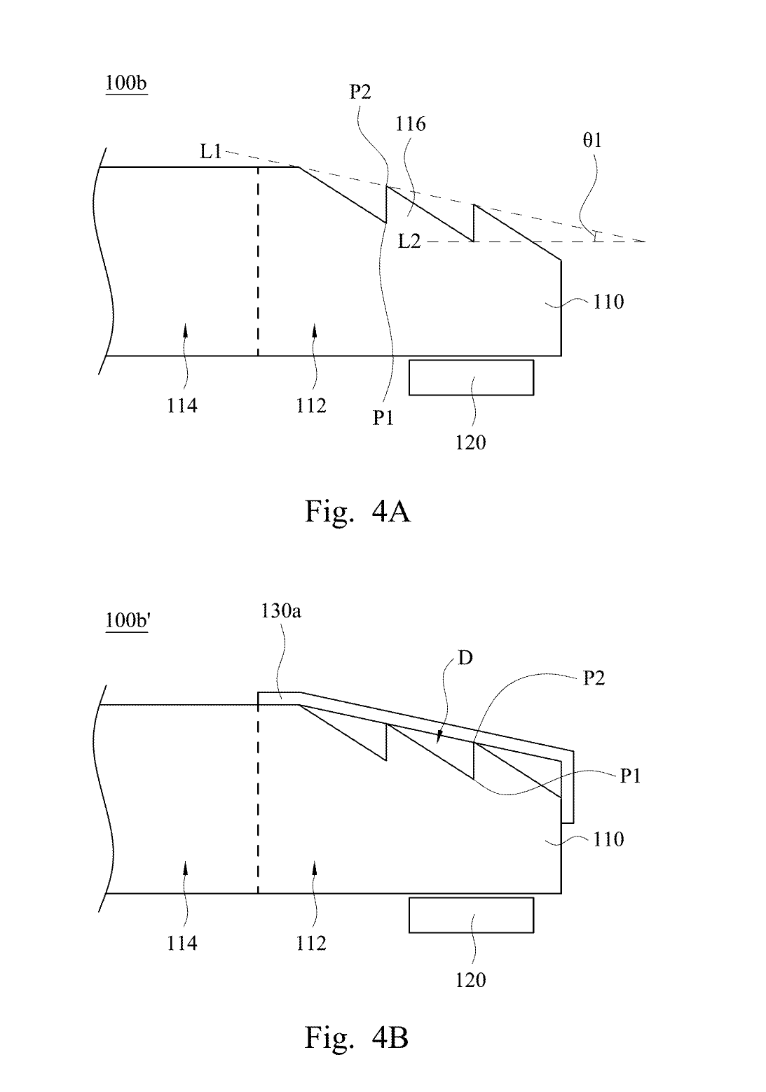

FIG. 4A is a cross-sectional view of a light guide module 100b according to an embodiment of the present invention, and the cross-sectional position is the same as FIG. 2. The light guide module 100b includes the light guide plate 110 and the light source 120. The difference between this embodiment and the embodiment shown in FIG. 2 is that an acute angle θ 1 is between a connection line L1 of the top portions P2 of the first concave convex structures 116 and a horizontal line L2. That is to say, the cross section of the first concave convex structures 116 is in an oblique arrangement. In this embodiment, the visible region 114 of the light guide plate 110 has good light emitting efficiency.

FIG. 4B is another embodiment different from the embodiment shown in FIG. 4A. The difference between this embodiment and the embodiment shown in FIG. 4A is that the light guide module 100b′ not only includes the light guide plate 110 and the light source 120, but also includes the reflector 130a. The reflector 130a covers the first concave convex structures 116. The gaps D are formed between the reflector 130a and the bottom portions P1 of the first concave convex structures 116, and the reflector 130a may be supported by the top portions P2 of the first concave convex structures 116.

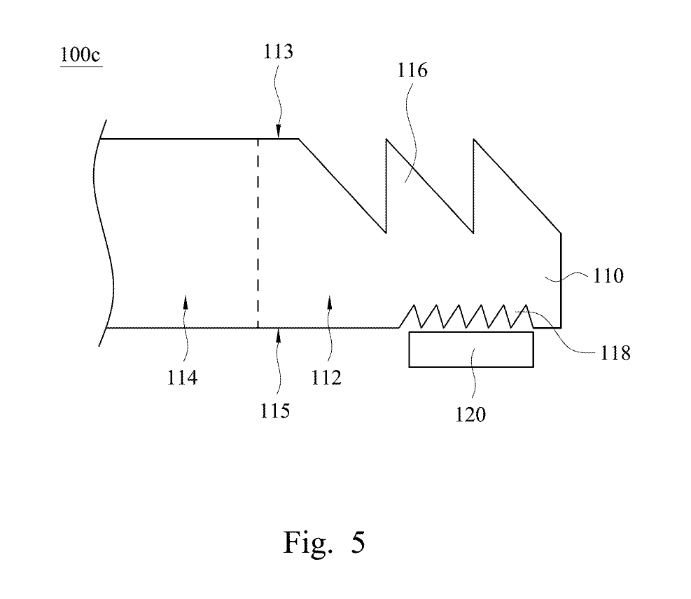

FIG. 5 is a cross-sectional view of a light guide module 100c according to an embodiment of the present invention, and the cross-sectional position is the same as FIG. 2. The light guide module 100c includes the light guide plate 110 and the light source 120. The difference between this embodiment and the embodiment shown in FIG. 2 is that the second surface 115 of the light mixed region 112 has a plurality of second concave convex structures 118, and the second concave convex structures 118 face the light source 120. When the light source 120 emits light, the light may enter the light mixed region 112 from the second concave convex structures 118, and the light of the light mixed region 112 may be reflected and refracted by the first and second concave convex structures 116, 118.

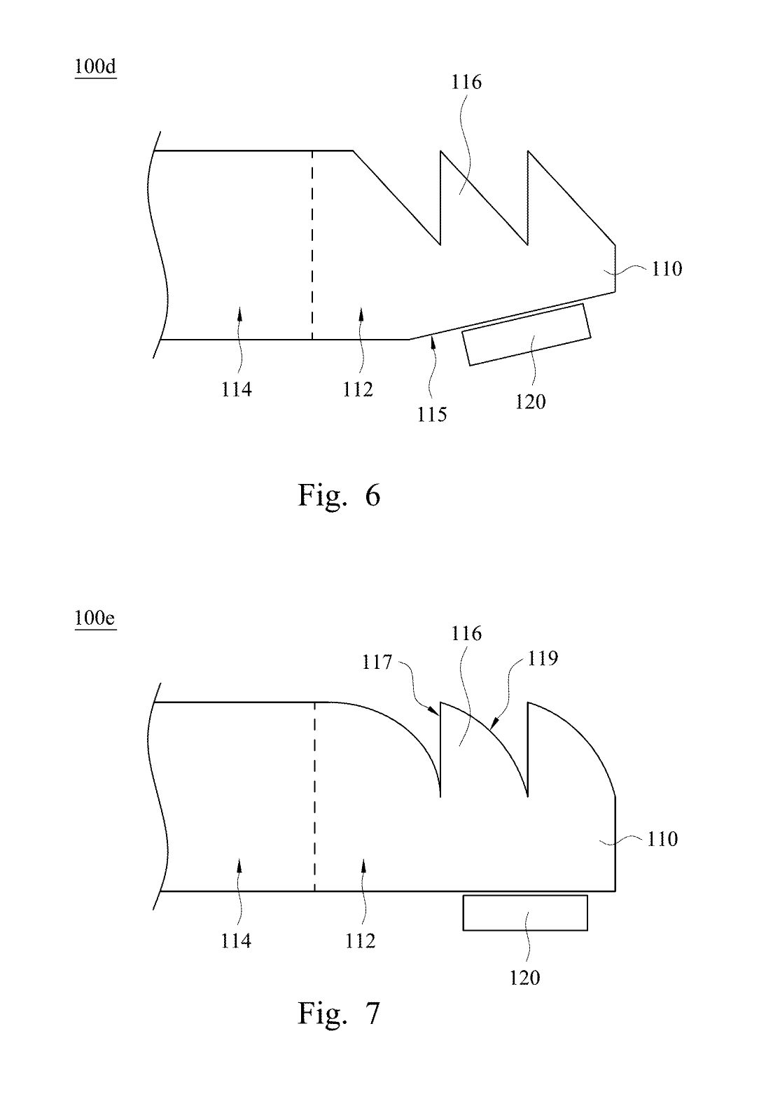

FIG. 6 is a cross-sectional view of a light guide module 100d according to an embodiment of the present invention, and the cross-sectional position is the same as FIG. 2. The light guide module 100d includes the light guide plate 110 and the light source 120. The difference between this embodiment and the embodiment shown in FIG. 2 is that the second surface 115 of the light mixed region 112 has an oblique surface, and the light source 120 is obliquely disposed along the oblique surface. When the light source 120 emits light, the light may enter the light mixed region 112 from the oblique surface.

FIG. 7 is a cross-sectional view of a light guide module 100e according to an embodiment of the present invention, and the cross-sectional position is the same as FIG. 2. The light guide module 100e includes the light guide plate 110 and the light source 120. The difference between this embodiment and the embodiment shown in FIG. 2 is that each of the first concave convex structures 116 includes two walls 117, 119 connected with each other, and the wall 117 is a flat surface, and the wall 119 is a curved surface. When the light source 120 emits light, the two walls 117, 119 of the first concave convex structures 116 may reflect the light to transfer to the visible region 114.

FIG. 8 is a cross-sectional view of a light guide module 100f according to an embodiment of the present invention, and the cross-sectional position is the same as FIG. 2. The light guide module 100f includes the light guide plate 110 and the light source 120. The difference between this embodiment and the embodiment shown in FIG. 7 is that the thicknesses of the first concave convex structures 116 are different. In this embodiment, the thicknesses of the first concave convex structures 116 are gradually increased from the left side to the right side.

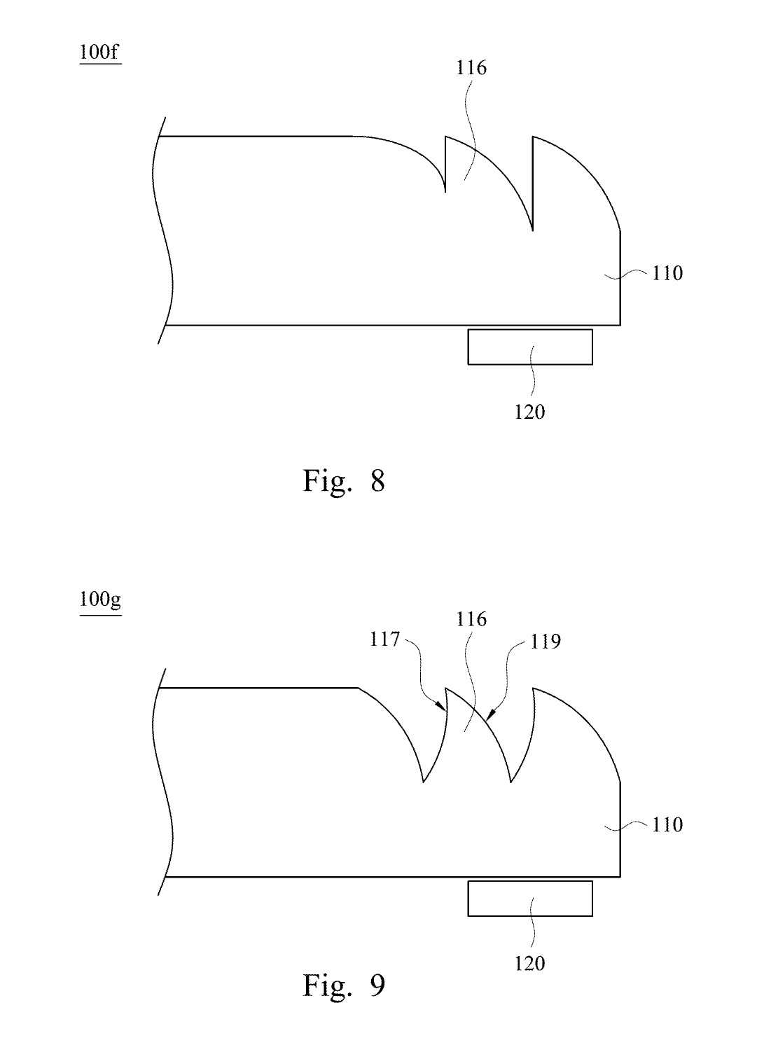

FIG. 9 is a cross-sectional view of a light guide module 100g according to an embodiment of the present invention, and the cross-sectional position is the same as FIG. 2. The light guide module 100g includes the light guide plate 110 and the light source 120. The difference between this embodiment and the embodiment shown in FIG. 2 is that each of the first concave convex structures 116 includes two walls 117, 119 connected with each other, and the two walls 117, 119 are curved surfaces. When the light source 120 emits light, the two walls 117, 119 of the first concave convex structures 116 may reflect the light to transfer to the visible region 114.

FIG. 10 is a top view of a light guide module 100h according to an embodiment of the present invention. The light guide module 100h includes the light guide plate 110 and the light source 120 (see FIG. 2). The difference between this embodiment and the embodiment shown in FIG. 1 is that the top view shape of the first concave convex structures 116 may is a polyline. The cross-sectional shape of the first concave convex structures 116 may be shown in FIG. 2 to FIG. 9.

FIG. 11 is a top view of a light guide module 100i according to an embodiment of the present invention. The light guide module 100i includes the light guide plate 110 and the light source 120 (see FIG. 2). The difference between this embodiment and the embodiment shown in FIG. 1 is that the top view shape of the first concave convex structures 116 is a curve. The cross-sectional shape of the first concave convex structures 116 may be shown in FIG. 2 to FIG. 9.

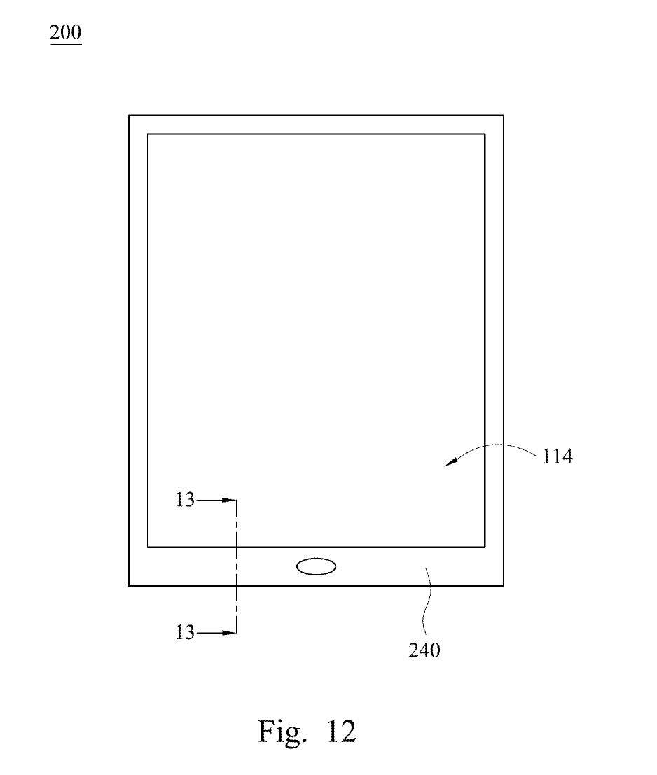

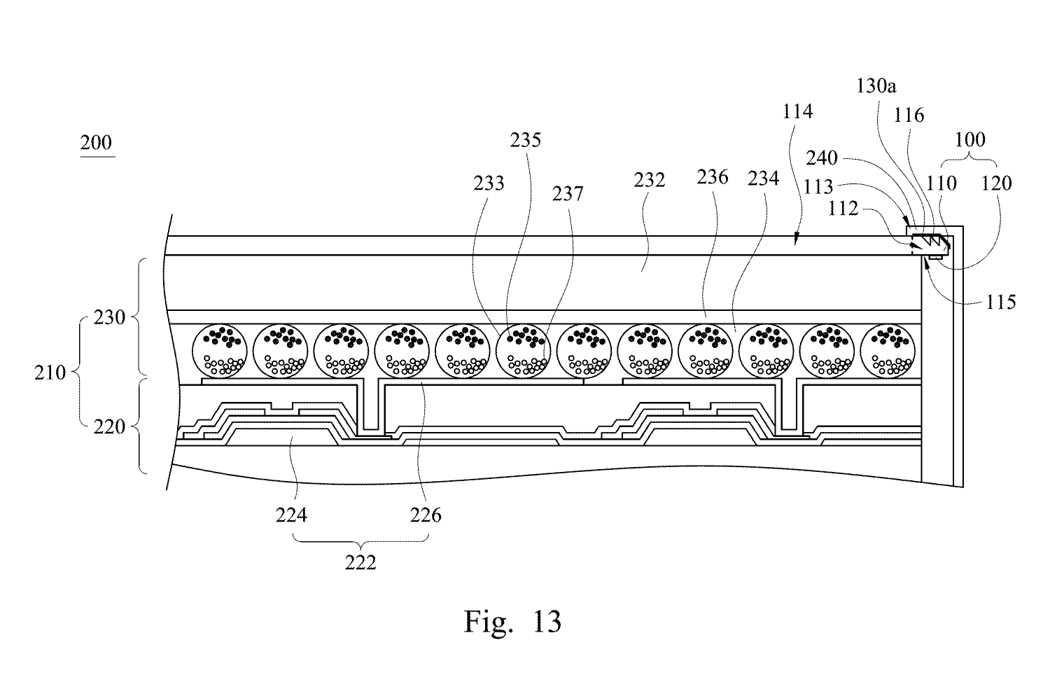

FIG. 12 is a top view of a bi-stable display device 200 according to an embodiment of the present invention. FIG. 13 is a cross-sectional view of the bi-stable display device 200 taken along line 13-13 shown in FIG. 12. As shown in FIG. 12 and FIG. 13, the bi-stable display device 200 includes a display back plate 210, the aforesaid light guide module 100, and a housing 240. The display back plate 210 includes an array substrate 220 and a front panel laminate (FPL) 230. The front panel laminate 230 is located on the array substrate 220 and includes a transparent substrate 232 and a display medium layer 234. The display medium layer 234 is between the array substrate 220 and the transparent substrate 232. The light guide module 100 is located on the display back plate 210 to provide a light for the display back plate 210. A transparent adhesion layer may be between the light guide plate 110 and the display back plate 210, and the index of the refraction of the transparent adhesion layer is smaller than the index of the refraction of the light guide plate 110. An anti-glare (AG) film, a cover lens, or a touch panel may be disposed above or under the light guide plate 110 depending on practical requirements. When one of the aforesaid or other elements is arranged on the light guide plate 110, the transparent adhesion layer may be also used between the light guide plate 110 and one of the elements. The light guide module 100 includes the light guide plate 110, the light source 120, and the reflector 130a. The light guide plate 110 has the light mixed region 112 and the visible region 114. The light mixed region 112 is at the edge of the light guide plate 110. The light mixed region 112 has a first surface 113 and a second surface 115 at an opposite side to the first surface 113. The first surface 113 has the first concave convex structures 116. The light source 120 faces the second surface 115 of the light mixed region 112. The reflector 130a covers the first concave convex structures 116. The gaps D (see FIG. 3) are formed between the reflector 130a and the bottom portions P1 (see FIG. 3) of the first concave convex structures 116, and the reflector 130a may be supported by the top portions P2 (see FIG. 3) of the first concave convex structures 116. The housing 240 surrounds the display back plate 210 and the light guide module 100, and covers the light mixed region 112.

Moreover, the array substrate 220 has a plurality of pixel units 222. Each of the pixel units 222 includes a thin film transistor 224 and a pixel electrode 226. The front panel laminate 230 further includes a common electrode 236. The display medium layer 234 includes a plurality of microencapsules 233. Each of the microencapsules 233 has a plurality of dark particles 235 and a plurality of bright particles 237. In addition, the common electrode 236 is located on the transparent substrate 232 and faces the pixel electrodes 226. The microencapsules 233 are located between the common electrode 236 and the pixel electrode 226.

In this embodiment, the light guide module 100 may be the front light module of the bi-stable display device 200. The display back plate 210 may changes electric fields formed between the common electrode 236 and each of the pixel electrodes 226, such that the bright particles 237 or the dark particles 235 are near upper side. When the bright particles 237 are near upper side, and the dark particles 235 are near lower side, the display back plate 210 can reflect an ambient incident light and so as to display as a bright face. On the contrary, when the bright particles 237 are near lower side, and the dark particles 235 are near upper side, the display back plate 210 does not reflect the ambient incident light and so as to display as a dark face. When the ambient light is not enough, the light source 120 may emit light, such that the light of the light source 120 enters the light mixed region 112 from the second surface 115, and next the light is reflected to the visible region 114 by the first concave convex structures 116 for providing the display back plate 210 with the incident light.

Furthermore, the thickness of the light source 120 is not limited by the thickness of the light guide plate 110, and the light of the light source 120 is only leaked from the first surface 113 and the first concave convex structures 116 of the light mixed region 112. However, the light mixed region 112 is covered by the housing 240, so that the light guide module 100 can improve the optical quality of the bi-stable display device 200.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light guide module comprising:
a light guide plate having a light mixed region and a visible region, wherein the light mixed region is at an edge of the light guide plate, the light mixed region has a first surface and a second surface at an opposite side to the first surface, and the first surface has a plurality of first concave convex structures;
a light source facing the second surface of the light mixed region, wherein when the light source emits a light, the light enters the light mixed region from the second surface, and the light is reflected to the visible region by the first concave convex structures; and
a reflector covering the first concave convex structures, wherein a plurality of gaps are formed between the reflector and a plurality of bottom portions of the first concave convex structures.

2. The light guide module of claim 1, wherein the reflector is made of a material comprising silver, aluminum, amalgam, silver paint, or white paint.

3. The light guide module of claim 1, wherein the light source is aligned within of the first concave convex structures.

4. The light guide module of claim 1, wherein a thickness of the light guide plate is h, and a thickness of each of the first concave convex structures is in a range from 1 micrometer to 0.9 h.

5. The light guide module of claim 1, wherein the second surface has a plurality of second concave convex structures, and the second concave convex structures face the light source.

6. The light guide module of claim 1, wherein the first concave convex structures are continuous concave convex surfaces.

7. The light guide module of claim 1, wherein a cross-sectional shape of each of the first concave convex structures is triangle.

8. The light guide module of claim 1, wherein each of the first concave convex structures comprises two walls connected with each other, and the two walls are flat surfaces.

9. The light guide module of claim 8, wherein an included angle of the two walls is in a range from 20 to 80 degrees.

10. The light guide module of claim 1, wherein each of the first concave convex structures comprises two walls connected with each other, and one of the two walls is a flat surface and the other is a curved surface.

11. The light guide module of claim 1, wherein each of the first concave convex structures comprises two walls connected with each other, and the two walls are curved surfaces.

12. The light guide module of claim 1, wherein a top view shape of the first concave convex structures is a straight line, a polyline, or a curve.

13. The light guide module of claim 1, wherein an acute angle is between a connection line of a plurality of top portions of the first concave convex structures and a horizontal line.

14. The light guide module of claim 1, wherein the light guide module is a front light module of a bi-stable display device.

15. The light guide module of claim 1, wherein the light source is a light emitting diode.

16. A bi-stable display device comprising:
a display back plate comprising:
an array substrate; and
a front panel laminate located on the array substrate and comprising a transparent substrate and a display medium layer, wherein the display medium layer is between the array substrate and the transparent substrate;
a light guide module located on the display back plate for providing a light for the display back plate, wherein the light guide module comprises:
a light guide plate having a light mixed region and a visible region, wherein the light mixed region is at an edge of the light guide plate, the light mixed region has a first surface and a second surface at an opposite side to the first surface, and the first surface has a plurality of first concave convex structures;
a light source facing the second surface of the light mixed region, wherein when the light source emits a light, the light enters the light mixed region from the second surface, and the light is reflected to the visible region by the first concave convex structures; and
a reflector covering the first concave convex structures, wherein a plurality of gaps are formed between the reflector and a plurality of bottom portions of the first concave convex structures; and
a housing surrounding the display back plate and the light guide module and covering the light mixed region.
